(19) United States
(12) Patent Application Publication
(10) Pub. No.: US 2012/0238444 A1
(43) Pub. Date: Sep. 20, 2012

(54) POWDER, METHOD OF PRODUCING POWDER AND ADSORPTION APPARATUS

(75) Inventors: Yukiko Murakami, Tokyo (JP); Mari Yokoyama, Tokyo (JP); Shintaro Kobayashi, Saitama (JP)

(73) Assignee: HOYA CORPORATION, Tokyo (JP)

(21) Appl. No.: 13/500,965

(22) PCT Filed: Oct. 4, 2010
(86) PCT No.: PCT/JP2010/067329

§ 371 Date: May 17, 2012

(30) Foreign Application Priority Data
Oct. 9, 2009 (JP) 2009-235719
Feb. 12, 2010 (JP) 2010-029445

(51) Int. Cl. B01J 20/281; B01J 20/30; B82Y 30/00; B82Y 40/00

(52) U.S. Cl. 502/400; 977/775; 977/902; 977/896

(57) ABSTRACT

The present invention is powder constituted from particles of a compound represented by the following general formula (1), (Ca₁₋ₐMₐ)₁₀(PO₄)₆((OH)_{1-b}F_{b})₂ (1), where in the formula M is a divalent metal element, and the following relations are satisfied: 0<a≦1 and 0≦b≦1. Each of the particles has a surface, a central part, a specific distance part in which a distance from the surface toward the central part is 15 nm, and an area part from the specific distance part to the central part. An amount of the divalent metal element is 3.2 wt % or more in the area part.

### TECHNICAL FIELD

The present invention relates to powder, a method of producing powder, and an adsorption apparatus.

### RELATED ART

Hydroxyapatite has high biocompatibility, high safety and the like. For this reason, the hydroxyapatite has been used generally as a material for stationary phase (adsorbent) of a chromatography (adsorption apparatus) which is used when a bio medicine such as an antibody and a vaccine is purified and isolated.

As the material for stationary phase of such a chromatography, in recent years, proposal is made to use powder which is constituted from particles of a compound obtained by substituting Ca included in hydroxyapatite with a divalent metal element M and further substituting a hydroxyl group of the hydroxyapatite with an elemental fluorine (e.g. see JP-A 2005-17046).

In an adsorption apparatus provided with the material for stationary phase (powder) obtained by substituting the Ca with the divalent metal element M and further substituting the hydroxyl group with the elemental fluorine, compounds having parts capable of bonding to the divalent metal element M with strong bonding power are adsorbed to the material for stationary phase specifically. Therefore, it becomes possible for the adsorption apparatus to reliably separate and purify the compounds with ease and a high yield. Further, since the elemental fluorine is included in the material for stationary phase, bonding powers between elements (ions) included in the material for stationary phase are improved. Therefore, it is possible to improve durability and solvent resistance (in particular, acid resistance) of the material for stationary phase.

Here, in general, the material for stationary phase, in which Ca is substituted with the divalent metal element M and further the hydroxyl group is substituted with the elemental fluorine, is produced as follows: First, a solution containing an ion of the divalent metal element M and an ion of the elemental fluorine is made contact with powder of hydroxyapatite (secondary particles). By doing so, the Ca and the hydroxyl group included in the hydroxyapatite are eliminated and then the Ca and the hydroxyl group are substituted with the divalent metal element M and the elemental fluorine, respectively.

However, in such a method, areas of particles of the powder, in which the Ca is substituted with the divalent metal element M and the hydroxyl group is substituted with elemental fluorine, are limited to areas in which the solution containing the ion of the divalent metal element M and the elemental fluorine is made contact with the particles of the hydroxyapatite. Therefore, the Ca and the hydroxyl group cannot be substituted with the divalent metal element M and the elemental fluorine, respectively, in a central part of each of the particles.

For these reasons, in the case where a sample solution containing compounds to be separated and purified has strong acidity or strong alkalinity, parts of particles of hydroxyapatite substituted with no divalent metal element M and no elemental fluorine are exposed due to resolution of surfaces of the particles constituting the powder (material for stationary phase). As a result, there arises a problem in that it becomes impossible to separate and purify a target compound with a high yield.

### SUMMARY OF THE INVENTION

It is an object of the present invention to provide powder that has excellent durability and is capable of reliably separating and purifying a target compound with ease when it is used for an adsorbent used in an adsorption apparatus. Furthermore, it is another object of the present invention to provide a method of producing powder that can produce such powder and an adsorption apparatus that uses such powder as an adsorbent.

These objects are achieved by the present inventions (1) to (20) described below.

(1) Powder constituted from particles of a compound represented by the following general formula (1),

(Ca₁₋ₐMₐ)₁₀(PO₄)₆((OH)_{1-b}F_{b})₂ (1)

where in the formula M is a divalent metal element, and the following relations are satisfied: 0<a≦1 and 0≦b≦1,

wherein each of the particles has a surface, a central part, a specific distance part in which a distance from the surface toward the central part is 15 nm, and an area part from the specific distance part to the central part, and

wherein an amount of the divalent metal element is 3.2 wt % or more in the area part.

According to the powder, when the powder is used for an adsorbent used in an adsorption apparatus, even if insides of the particles of the powder are exposed, it is possible for the powder to reliably exhibit functions as the adsorbent.

(2) In the powder described in the above-mentioned item (1), the “b” in the general formula (1) satisfies a relation of 0<b≦1, wherein the compound is constituted of hydroxyapatite, at least a part of Cas of the hydroxyapatite is substituted with the divalent metal element M and at least a part of hydroxyl groups is substituted with an elemental fluorine.

According to the powder, it is possible to exhibit excellent durability and reliably separate and purify a target compound with ease when the powder is used for an adsorbent used in an adsorption apparatus.

(3) In the powder described in the above-mentioned item (2), an amount of the divalent metal element M is 3.2 wt % or more in the whole of the particles of the powder.

The powder constituted from the particles including the divalent metal element M within such a range means powder of particles in which the divalent metal element M is substantially uniformly included in the insides. When the powder is used for an adsorbent used in an adsorption apparatus, even if any parts of the particles of the powder are exposed, it is possible for the powder to reliably exhibit functions as the adsorbent.

(4) In the powder described in the above-mentioned item (2) or (3), an amount of the elemental fluorine is in a range of 0.37 to 3.7 wt % in the area part of each of the particles.

When the powder is used for an adsorbent used in an adsorption apparatus, even if insides of the particles are exposed, it becomes possible for the powder (adsorbent) to exhibit excellent durability and excellent solvent resistance.

(5) In the powder described in the above-mentioned items (2) to (4), a content of the elemental fluorine is in a range of 0.37 to 3.7 wt % in the whole of the particles of the powder.

The powder constituted from the particles including the elemental fluorine within such a range means powder of particles in which the elemental fluorine is substantially uniformly included in the insides. When the powder is used for an adsorbent used in an adsorption apparatus, even if any parts of the particles of the powder are exposed, it becomes possible for the powder (adsorbent) to exhibit excellent durability and excellent solvent resistance.

(6) In the powder described in the above-mentioned items (1) to (5), the particles are obtained by drying a slurry containing primary particles of the compound represented by the general formula (1) and aggregates thereof and then granulating the primary particles and the aggregates.

According to the powder, the particles of the powder are constituted of the compound represented by the above general formula (1) over the particles.

(7) In the powder described in the above-mentioned item (6), the compound is constituted of hydroxyapatite, the primary particles of the compound represented by the general formula (1) are obtained by substituting the Ca and the hydroxyl group included in the primary particles of the hydroxyapatite with the divalent metal element M and the elemental fluorine, respectively.

According to the powder, the particles of the powder are constituted of the compound represented by the above general formula (1) over the particles.

(8) In the powder described in the above-mentioned items (1) to (7), the compound represented by the general formula (1) forms an apatite structure.

According to the powder, the particles of the powder becomes chemically stable. Therefore, when the powder is used for an adsorbent used in an adsorption apparatus, the powder (adsorbent) exhibits excellent durability and excellent solvent resistance.

(9) In the powder described in the above-mentioned item (1), the “b” in the general formula (1) is 0, wherein the compound is represented by the following general formula (2) in which at least a part of Cas of the hydroxyapatite is substituted with the divalent metal element M: (Ca₁₋ₐMₐ)₁₀(PO₄)₆(OH)₂ (2)

where in the formula the following relation is satisfied: 0<a≦1.

According to the powder, it is possible to exhibit excellent durability and reliably separate and purify a target compound with ease when the powder is used for an adsorbent used in an adsorption apparatus.

(10) In the powder described in the above-mentioned item (9), an amount of the divalent metal element M is 5.0 wt % or more in the area part of each of the particles.

According to the powder, when the powder is used for an adsorbent used in an adsorption apparatus, even if insides of the particles of the powder are exposed, it is possible for the powder to reliably exhibit functions as the adsorbent.

(11) In the powder described in the above-mentioned item (9) or (10), a content of the divalent metal element M is 5.0 wt % or more in the whole of the particles of the powder.

The powder constituted from the particles including the divalent metal element M within such a range means powder of particles in which the divalent metal element M is substantially uniformly included in the insides. When the powder is used for an adsorbent used in an adsorption apparatus, even if any parts of the particles of the powder are exposed, it is possible for the powder to reliably exhibit functions as the adsorbent.

(12) In the powder described in the above-mentioned items (9) to (11), the particles are obtained by drying a slurry containing primary particles of the compound represented by the general formula (2) and aggregates thereof and then granulating the primary particles and the aggregates.

According to the powder, the particles of the powder are constituted of the compound represented by the above general formula (2) over the particles.

(13) In the powder described in the above-mentioned item (12), the compound is constituted of hydroxyapatite, the primary particles of the compound represented by the general formula (2) are obtained by substituting the Ca included in the primary particles of the hydroxyapatite with the divalent metal element M.

According to the powder, the particles of the powder are constituted of the compound represented by the above general formula (2) over the particles.

(14) A method of producing the powder defined in the above-mentioned item (1), the method comprising:

preparing a first liquid containing a calcium-based compound containing the Ca;

preparing a second liquid containing the divalent metal element M to obtain an ion thereof;

preparing a third liquid containing phosphoric acid;

mixing the first liquid, the second liquid and the third liquid to obtain a first mixture;

reacting the calcium-based compound, the ion of the divalent metal element M and the phosphoric acid in the first mixture to obtain a slurry containing primary particles of the compound represented by the general formula (1) and aggregates thereof; and

granulating the primary particles and the aggregates contained in the slurry to thereby obtain the powder constituted from the particles.

This makes it possible to reliably produce powder constituted from particles which are constituted of the compound represented by the above general formula (1) over the particles and in which a content of the divalent metal element M in the central part is 5.0 wt % or more.

(15) In the method described in the above-mentioned item (14), the mixing the first liquid, the second liquid and the third liquid is performed by mixing the first liquid and the second liquid to obtain a second mixture and then mixing the third liquid with the second mixture.

This makes it possible to uniformly mix the second liquid and the third liquid with the first liquid, thereby assisting the uniformity of a ratio of substituting with the divalent metal element M in the compound represented by the above general formula (1).

(16) In the method described in the above-mentioned item (14) or (15), the ion of the divalent metal element M is derived from an oxide of the divalent metal element M as an ion source.

When primary particles of hydroxyapatite are synthesized, Ca of the primary particles is efficiently substituted with the divalent metal element M. As a result, the divalent metal element M is reliably introduced into a crystal lattice of the hydroxyapatite. Further, it is possible to reliably suppress or prevent impurities from being mixed in the primary particles of the compound represented by the above general formula (1) to be synthesized.

(17) In the method described in the above-mentioned item (14), the method further comprises preparing a fourth liquid containing hydrogen fluoride, wherein the mixing the first liquid, the second liquid and the third liquid is performed by mixing the first liquid, the second liquid, the third liquid and the fourth liquid, and the reacting the calcium-based compound, the ion of the divalent metal element M and the phosphoric acid is performed by reacting the calcium-based compound, the ion of the divalent metal element M, the phosphoric acid and the hydrogen fluoride in the first mixture.

This makes it possible to reliably produce powder constituted from the particles of the compound represented by the above general formula (1) over the particles.

(18) In the method described in the above-mentioned item (17), the mixing the first liquid, the second liquid and the third liquid is performed by mixing the first liquid with the second liquid to obtain a second mixture, mixing the third liquid with the second mixture to obtain a third mixture, and then mixing the fourth liquid with the third mixture.

By completing such steps, first, the calcium compound, the ion of the divalent metal element M and the phosphoric acid are reacted with each other to obtain a reactant having a hydroxyapatite structure. Thereafter, the hydroxyl group is substituted with the elemental fluorine by making hydrogen fluoride contact with the reactant. Therefore, it is possible to reliably synthesize the compound represented by the above general formula (1) having the hydroxyapatite structure. As a result, it becomes possible to constitute of the compound over the particles of the powder.

(19) In the method described in the above-mentioned item (17) or (18), the ion of the divalent metal element M is derived from at least one of an oxide and a nitric compound of the divalent metal element M an ion source.

When primary particles of hydroxyapatite are synthesized, Ca and hydroxyl group of the primary particles are efficiently substituted with the divalent metal element M and elemental fluorine, respectively. As a result, the metal element M and the elemental fluorine are reliably introduced into a crystal lattice of apatite. Further, it is possible to reliably suppress or prevent impurities from being mixed in the primary particles of the compound represented by the above general formula (1) to be synthesized.

(20) An adsorption apparatus provided with the powder described in the above-mentioned items (1) to (13) or sintered powder obtained by sintering the powder.

This makes it possible to exhibit excellent durability and reliably separate and purify a target material with ease.

The powder of the present invention is constituted from the particles of apatite in which at least a part of Cas of hydroxyapatite is substituted with the divalent metal element M. Therefore, even if the insides of the particles are exposed by making the powder contact with a liquid having strong acidity or strong alkalinity, thereby dissolving the surfaces of the particles of the powder, it is possible to stably separate and purify a target material with a high yield. Likewise, even if the particles of the powder crash, it is possible to suppress functions of the particles from being lowered.

Further, the powder of the present invention is constituted from the particles of apatite in which at least a part of Cas of hydroxyapatite is substituted with the divalent metal element M and at least a part of hydroxyl groups is substituted with the elemental fluorine. Therefore, it is possible to exhibit excellent acid resistance in addition to the above effects.

In particular, by setting an amount of the divalent metal element M to 5.0 wt % in an area from a part, in which a distance from the surface of the particle of the powder to a central part of the particle is 15 nm, to the central part of particle, it is possible to reliably exhibit the functions of apatite in which at least a part of Cas of hydroxyapatite is substituted with the divalent metal element M. Therefore, it is possible to more stably separate and purify the target material with the high yield.

Also particularly, by setting amounts of the divalent metal element M and the elemental fluorine to 3.2 wt % or more and within a range of 0.37 to 3.7 wt %, respectively, in the area from the part, in which the distance from the surface of the particle of the powder to the central part of the particle is 15 nm, to the central part, it is possible to reliably exhibit the functions of apatite in which at least a part of Cas of hydroxyapatite is substituted with the divalent metal element M and at least a part of the hydroxyl groups is substituted with the elemental fluorine. Therefore, it is possible to more stably separate and purify the target material with the high yield.

### BRIEF DESCRIPTION OF THE DRAWINGS

FIG. 1 is a sectional view which shows one example of an adsorption apparatus to be used in the present invention.

FIG. 2 shows results of XRD analyses of sintered powders obtained from slurries in the Examples 1 to 3 and sintered powders obtained in the Comparative Example 1 and the Reference Example 1.

FIG. 3 shows absorbance curves measured when dihistidine contained in a sample is separated by using an adsorption apparatus of each of the Example 1 and the Comparative Example 1.

FIG. 4 shows results of XRD analyses of sintered powders obtained from slurries in the Examples 1, 5 to 9 and sintered powder obtained in the Comparative Example 1.

FIG. 5 shows absorbance curves measured when histidine contained in a sample is separated by using an adsorption apparatus of each of the Example 4 and the Comparative Example 1.

FIG. 6 shows results of X-ray photoelectron spectrometer analyses of dried powders obtained in the Example 4 and the Comparative Example 2.

FIG. 7 shows results of X-ray photoelectron spectrometer analyses of dried powders obtained in the Example 4 and the Comparative Example 1.

### BEST MODE FOR CARRYING OUT THE INVENTION

Hereinbelow, powder, a method of producing powder and an adsorption apparatus according to the present invention will be described in detail with reference to their preferred embodiments.

First, prior to the descriptions of the powder and the method of producing the powder according to the present invention, one example of the adsorption apparatus (separation apparatus) provided with the powder according to the present invention will be described.

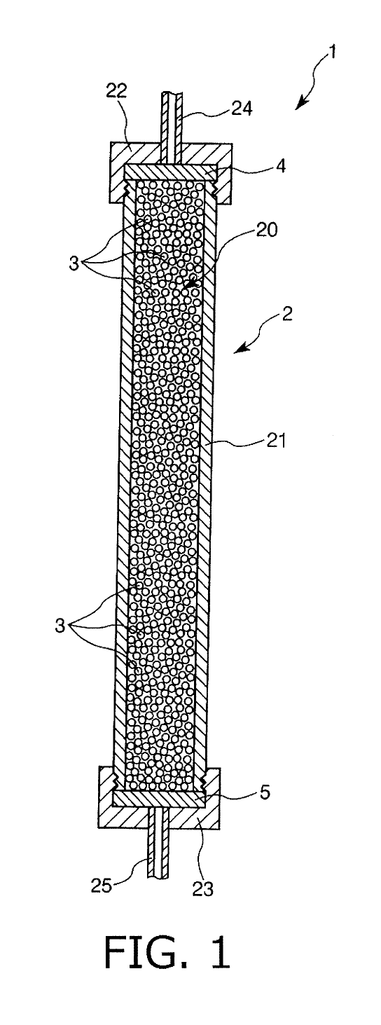

FIG. 1 is a sectional view which shows one example of an adsorption apparatus to be used in the present invention. It is to be noted that in the following description, the upper side and the lower side in FIG. 1 will be referred to as “inflow side” and “outflow side”, respectively.

More specifically, the inflow side means a side from which liquids such as a sample solution (i.e., a liquid containing a sample) and an eluate are supplied into the adsorption apparatus to separate (purify) a target material to isolate, and the outflow side means a side located on the opposite side from the inflow side, that is, a side through which the liquids described above discharge out of the adsorption apparatus as a discharge liquid.

The adsorption apparatus 1 shown in FIG. 1, which is used for separating (isolating) the target material to isolate from the sample solution, includes a column 2, a granular adsorbent (filler) 3, and two filter members 4 and 5.

The column 2 is constituted from a column main body 21 and caps 22 and 23 to be attached to the inflow-side end and outflow-side end of the column main body 21, respectively.

The column main body 21 is formed from, for example, a cylindrical member. Examples of a constituent material of each of the parts (members) constituting the column 2 including the column main body 21 include various glass materials, various resin materials, various metal materials, and various ceramic materials and the like.

An opening of the column main body 21 provided on its inflow side is covered with the filter member 4, and in this state, the cap 22 is threadedly mounted on the inflow-side end of the column main body 21. Likewise, an opening of the column main body 21 provided on its outflow side is covered with the filter member 5, and in this state, the cap 23 is threadedly mounted on the outflow-side end of the column main body 21.

The column 2 having such a structure as described above has an adsorbent filling space 20 which is defined by the column main body 21 and the filter members 4 and 5, and at least a part of the adsorbent filling space is filled with the adsorbent 3 (in this embodiment, almost the entire of the adsorbent filling space 20 is filled with the adsorbent 3).

A volumetric capacity of the adsorbent filling space 20 is appropriately set depending on the volume of a sample solution to be used. Such a volumetric capacity is not particularly limited, but is preferably in a range of about 0.1 to 100 mL, and more preferably in a range of about 1 to 50 mL per 1 mL of the sample solution.

By setting a size of the adsorbent filling space 20 to a value within the above range and by setting a size of the adsorbent 3 (which will be described later) to a value within a range as will be described later, it is possible to selectively isolate (purify) the target material to isolate (isolation material) from the sample solution. In other words, it is possible to reliably separate the isolation material such as a protein, an antibody and a vaccine from contaminating substances (foreign substances) other than the isolation material contained in the sample solution.

Further, liquid-tightness between the column main body 21 and the caps 22 and 23 is ensured by attaching the caps 22 and 23 to the openings of the column main body 21.

An inlet pipe 24 is liquid-tightly fixed to the cap 22 at substantially the center thereof, and an outlet pipe 25 is also liquid-tightly fixed to the cap 23 at substantially the center thereof. The sample solution (liquid) described above is supplied to the adsorbent filling space 20 through the inlet pipe 24 and the filter member 4. The sample solution supplied to the adsorbent filling space 20 passes through gaps between particles of the adsorbent 3 and then discharges out of the column 2 through the filter member 5 and the outlet pipe 25. At this time, the isolation material and the contaminating substances other than the isolation material contained in the sample solution (sample) are separated from each other based on a difference in degree of adsorption of each of the isolation material and the contaminating substances with respect to the adsorbent 3 and a difference in degree of affinity of each of the isolation material and the contaminating substances with respect to an eluate.

Each of the filter members 4 and 5 has a function of preventing the adsorbent 3 from discharging out of the adsorbent filling space 20. Further, each of the filter members 4 and 5 is formed of a nonwoven fabric, a foam (a sponge-like porous body having communicating pores), a woven fabric, a mesh or the like, which is made of a synthetic resin such as polyurethane, polyvinyl alcohol, polypropylene, polyetherpolyamide, polyethylene terephthalate, or polybutylene terephthalate.

In the present embodiment, the adsorbent 3 filled into the adsorbent filling space 20 in the adsorption apparatus 1 is constituted from the powder of the present invention or sintered powder thereof. Hereinafter, descriptions will be made on the powder and the method of producing the powder according to the present invention.

First, a description will be made on the powder according to the present invention.

The powder according to the present invention is constituted from particles of a compound in which at least a part of Cas of hydroxyapatite is substituted with a divalent metal element M and at least a part of hydroxyl groups of the hydroxyapatite is substituted with an element fluorine, and which are represented by the following general formula (1).

(Ca₁₋ₐMₐ)₁₀(PO₄)₆((OH)_{1-b}F_{b})₂ (1)

where in the formula 0<a≦1 and 0≦b≦1.

The compound may not include an elemental fluorine, which means that b is 0, as shown in the general formula (1). First, a description will be made on a case that the compound includes elemental fluorine.

<Metal-Element M, Elemental-Fluorine Substituted-Apatite>

The compound is apatite in which at least a part of Cas of hydroxyapatite is substituted with another divalent metal element M and at least a part of hydroxyl groups of the hydroxyapatite is substituted with the element fluorine (hereinafter, referred to as “metal-element M, elemental-fluorine substituted-apatite”).

In this regard, it is to be noted that nevertheless the particles of the powder according to the present invention are constituted of the compound in which at least a part of Cas of hydroxyapatite is substituted with the divalent metal element M and at least a part of hydroxyl groups of the hydroxyapatite is substituted with the element fluorine, the particles maintain an apatite structure. As a result, the particles of the powder become chemically stable, so that the powder (adsorbent) exhibits excellent durability and excellent solvent resistance when the powder is used for powder used in the adsorption apparatus.

By substituting at least a part of Cas with the divalent metal element M, compounds having parts which are capable of bonding to the divalent metal element M with high affinity (high bonding power) specifically adsorb to the particles of the powder (adsorbent 3). As a result, it becomes possible for the particles of the powder to selectively adsorb to the compounds having the parts which are capable of bonding to the divalent metal element M with the high affinity as compared with other compounds.

Further, by substituting at least a part of hydroxyl groups with the element fluorine, it is possible to improve durability and solvent resistance (in particular, acid resistance) of the metal-element M, elemental-fluorine substituted-apatite because bonding powers between elements (ions) constituting the metal-element M, elemental-fluorine substituted-apatite are improved. Therefore, for example, it becomes possible to separate proteins in an acid solution.

In the particles of the powder, particularly, divalent metal element M to become an adsorption site is introduced into the particles by substituting with Ca in a crystal structure of apatite. Therefore, the divalent metal element M is firmly adsorbed to the compound constituting the particles of the powder, thereby preventing the divalent metal element M from being eliminated from the compound. As a result, when the powder or a sintered material thereof is used for the adsorbent 3, adsorption capability of the adsorbent 3 is maintained for a long period of time with preventing the divalent metal element M (or ions thereof) from being mixed into a liquid discharged from the column 2 (adsorption apparatus 1).

Furthermore, a whole of the particles of the powder is constituted of apatite in which at least a part of Cas is substituted with another divalent metal element M and at least a part of hydroxyl groups is substituted with the element fluorine. Therefore, even if the insides of the particles are exposed by making the powder contact with the sample solution which contains a compound to be separated and purified and has strong acidity or strong alkalinity, and then dissolving surfaces of the particles, it is possible for the particles of the powder to exhibit enough functions as the metal-element M, elemental-fluorine substituted-apatite. In other words, when the powder or the sintered material thereof according to the present invention is used for the adsorbent 3, the adsorbent 3 has excellent durability because it can stably separate and purify a target compound with a high yield.

Here, examples of compounds specifically adsorbed to the divalent metal element M, namely the compounds to be separated from the sample solution include compounds having at least two unshared electron pairs. The compounds form coordinate bonds between parts having the unshared electron pair (e.g. substituent groups and side chains) and the divalent metal element M (that is, form chelates). Since the coordinate bonds becomes stronger than normal adsorption (electrical bonding), it is possible to reliably adsorb the compounds, separate the compounds from other compounds and purify (isolate) the compounds by using the powder constituted from the particles of the metal-element M, elemental-fluorine substituted-apatite as the adsorbent 3.

Further, examples of the compounds having at least two unshared electron pairs include various kinds of compounds. In particular, a sulfur amino acid, a heterocyclic amino acid, or a polypeptide having them as an amino-acid residue has excellent chelate-forming ability to the divalent metal element M. In other words, the particles of the powder have excellent specific adsorption capability with respect to the sulfur amino acid, the heterocyclic amino acid, or the polypeptide having them as the amino-acid residue.

Among them, cysteine in the sulfur amino acid and histidine or tryptophan in the heterocyclic amino acid have more the excellent chelate-forming ability to the divalent metal element M, respectively. Therefore, the adsorbent 3 using the powder according to the present invention or the sintered material thereof (adsorption apparatus 1) is reliably used for the separation and the purification of the amino acid or the polypeptide (protein) having a relative number of the amino acids as the amino-acid residues. In this regard, concrete examples of the protein include myoglobin, a recombinant protein in which a polypeptide consisting of a plurality of cysteines, histidine or tryptophan is introduced (added) as a tag, and the like.

Further, it is preferred that the divalent metal element M in the above general formula (1) is a divalent transition metal element. This is because the divalent transition metal element form chelates between the compounds as described above and the divalent transition metal element with ease.

Examples of the divalent transition metal element include Ni, Co, Cu, Zn and the like. Among them, particularly, Zn is preferable. This is because Zn is substituted with Ca of apatite with ease and efficiently introduced into the crystal lattice of apatite. Further, since Zn has high affinity to the amino acid described above, it is possible to adsorb the amino acid or the protein having the amino acid as the amino-acid residues with high accuracy.

A substituent ratio of “a” included in the above general formula (1), namely the divalent metal element M is not particularly limited as long as the substituent ratio is as large as possible, but is preferably in a range of about 0.01 to 1 and more preferably in a range of about 0.05 to 1. If the “a” is much smaller than the lower limit value noted above, there is a fear that the adsorbent 3 cannot exhibit enough specific adsorption capability to the compounds described above depending on a kind of divalent metal element M and the like.

Also, a substituent ratio of “b” included in the above general formula (1), namely the elemental fluorine is not particularly limited as long as the substituent ratio is as large as possible, but is preferably in a range of about 0.3 to 1 and more preferably in a range of about 0.5 to 1.

Further, as shown in FIG. 1, the particles of the powder described above preferably have a particulate (granular) shape, but may have another shape such as a pellet (small block)-like shape or a block-like shape (e.g., a porous body in which adjacent pores communicate with each other or a honeycomb shape). By forming the particles having the particulate shape, it is possible to increase its surface area, and thereby improving adsorbed amount of the compounds described above.

Further, it is preferred that the divalent metal element M is uniformly distributed in the insides of the particles of the powder according to the present invention.

Concretely, it is preferred that an amount of the divalent metal element M is 3.2 wt % or more in the inside of each of the particles, namely in an area from a surface of the particle to a central part of the particle. In particular, it is preferred that the amount of the divalent metal element M is 3.2 wt % or more in an area from a part of the particle, in which a distance from the surface of the particle of the powder toward the central part of the particle (hereinafter, referred to as “depth of the particle of the powder”) is 15 nm, to the central part of the particle. Furthermore, it is preferred that the amount of the divalent metal element M is 3.2 wt % or more in an area from a part, in which the depth of the particle of the powder is 30 nm, to the central part of the particle. By setting the amount of the divalent metal element M in the areas from the parts of the depth of the particle of the powder to the central part to 3.2 wt % or more, even if the inside of the particle is exposed, it is possible for the powder to reliably exhibit functions as the adsorbent 3.

Further, it is also preferred that the elemental fluorine is uniformly distributed in the insides of the particles of the powder according to the present invention.

Concretely, it is preferred that an amount of the elemental fluorine is in a range of 0.37 to 3.7 wt % in the inside of each of the particles, namely in the area from the surface to the central part of the particle. In particular, it is preferred that the amount of the elemental fluorine is also in a range of 0.37 to 3.7 wt % in the area from the part, in which the depth of the particle of the powder is 15 nm, to the central part of the particle. Furthermore, it is preferred that the amount of the elemental fluorine is also in a range of 0.37 to 3.7 wt % in the area from the part, in which the depth of the particle of the powder is 30 nm, to the central part. By setting the amount of the elemental fluorine in the areas from the parts of such a depth of the particle of the powder to the central part to the range of 0.37 to 3.7 wt %, even if the inside of the particle is exposed, it becomes possible for the powder to exhibit excellent durability and excellent solvent resistance. In addition, it becomes possible for the particles of the powder to reliably maintain the apatite structure.

Further, it is preferred that an content of the divalent metal element M is 3.2 wt % or more in the area from the surface to the central part of the particle of the powder according to the present invention. In particular, the content of the divalent metal element M is preferably 3.2 wt % or more in the area from the part, in which the depth of the particle of the powder is 15 nm, to the central part of the particle, more preferably in a range of about 4.0 to 9.6 wt %, and even more preferably in a range of about 6.0 to 6.3 wt %. By falling the content of the divalent metal element M in the area from the part in which the depth of the particle of the powder is 15 nm to the central part within such a range, when the inside of the particle is exposed, it is possible to reliably exhibit the functions as the adsorbent 3 to the exposed part (inside).

Further, it is preferred that the content of the elemental fluorine is in a range of 0.37 to 3.7 wt % in the area from the surface to the central part of the particle of the powder according to the present invention. In particular, the content of the elemental fluorine is also preferably in a range of 0.37 to 3.7 wt % in the area from the part in which the depth of the particle of the powder is 15 nm to the central part, more preferably in a range of about 0.4 to 2.2 wt %, and even more preferably in a range of about 1.0 to 2.0 wt %. By falling the content of the elemental fluorine in the area from the part in which the depth of the particle of the powder is 15 nm to the central part within such a range, even if the inside of the particle of the powder is exposed, it becomes possible for the powder to exhibit excellent durability and excellent solvent resistance in the exposed part (inside).

Further, the content of the divalent metal element M is preferably 3.2 wt % or more in the whole of the powder, more preferably in a range of about 4.0 to 9.6 wt %, and even more preferably in a range of about 6.0 to 6.3 wt %. The powder in which the content of the divalent metal element M falls within such a range means powder in which the divalent metal element M is substantially uniformly included in the insides of the particles. Therefore, even if any parts of the particles of the powder are exposed, it is possible for the powder to reliably exhibit the functions as the adsorbent 3.

Further, the content of the elemental fluorine is also in a range of 0.37 to 3.7 wt % in the whole of the powder, more preferably in a range of about 0.4 to 2.2 wt %, and even more preferably in a range of about 1.0 to 2.0 wt %. The powder in which the content of the elemental fluorine falls within such a range means powder in which the elemental fluorine is substantially uniformly included in the insides of the particles. Therefore, even if any parts of the particles of the powder are exposed, it becomes possible for the powder (adsorbent 3) to exhibit excellent durability and excellent solvent resistance.

An average particle size of the particles of the powder is not particularly limited, but is preferably in a range of about 0.1 to 150 μm, more preferably in a range of about 1 to 80 μm, and even more preferably in a range of about 1 to 40 μm. The powder which is constituted from the particles having relatively a small particle size within such a range is preferably used for the adsorption apparatus of the present invention. Further, by using the powder which is constituted from the particles having such an average particle size for the adsorbent 3, it is possible to reliably prevent the clogging from generating to the filter member 5 and ensure a sufficient surface area of the adsorbent 3.

In addition, a specific surface area of the particles of the powder is preferably 30 m²/g or more, and more preferably in a range of about 50 to 100 m²/g, and even more preferably in a range of about 75 to 100 m²/g. When the powder which is constituted from the particles having a large specific surface area within such a range is used for the adsorbent 3, it is possible to increase an opportunity to make a material to be isolated (hereinafter, referred to as “isolation material”) contact with the adsorbent 3, thereby improving interaction between the isolation material and adsorbent 3. Therefore, the adsorbent 3 exhibits excellent adsorption capability with respect to the isolation material. In this regard, it is to be noted that the powder constituted from the particles having such a large specific surface area can be obtained by using the method of producing the powder according to the present invention described later. This will be described later.

In this regard, in addition to the case where almost the entire of the adsorbent filling space 20 is filled with the adsorbent 3 which is constituted from the powder of the present invention or the sintered powder thereof as this embodiment, it is to be noted that the adsorbent filling space 20 of the adsorption apparatus of the present invention may be partially filled with the adsorbent 3 (e.g., a part of the adsorbent filling space 20 located on its one side where the inlet pipe 24 is provided may be filled with the adsorbent 3). In this case, the remaining part of the adsorbent filling space 20 may be filled with another adsorbent.

The powder of the present invention as described above can be produced by the method of producing the powder of present invention as follows.

The method of producing the powder of present invention includes a liquid preparation step S1, a metal-element M, elemental-fluorine substituted-apatite synthesis step S2 and a granulation step S3. The liquid preparation step S1 is a step of preparing each of liquids to be used in the present invention. The metal-element M, elemental-fluorine substituted-apatite synthesis step S2 is a step of mixing the prepared liquids with each other to obtain a slurry containing primary particles of the metal-element M, elemental-fluorine substituted-apatite and aggregates thereof. The granulation step S3 is a step of granulating the primary particles and the aggregates to obtain powder which is constituted from secondary particles of the compound represented by the above general formula (1). Hereinafter, a description will be made on these steps one after another.

[S1] Liquid Preparation Step (First Step)

[S1-1] First Liquid (Solution Containing Calcium-Based Compound) Preparation Step

First, a first liquid containing a calcium-based compound containing calcium as a calcium source is prepared.

Examples of the calcium-based compound as the calcium source include, but not limited thereto, calcium hydroxide, calcium oxide, calcium nitrate and the like. These compounds may be used singly or in combination of two or more of them. Among them, calcium hydroxide is particularly preferred. This makes it possible to reliably obtain the metal-element M, elemental-fluorine substituted-apatite in which impurities are contained at a low level in the compound represented by the above general formula (1) in which at least a part of Cas of hydroxyapatite is substituted with the divalent metal element M, which will be synthesized in the next step [S2].

A solution or suspension containing the calcium-based compound can be used as the first liquid. In the case where the calcium-based compound is calcium hydroxide, a calcium hydroxide suspension in which the calcium hydroxide is suspended in water is used preferably. If the metal-element M, elemental-fluorine substituted-apatite is synthesized by using such a calcium hydroxide suspension in the next step [S2], it is possible to obtain fine primary particles of the metal-element M, elemental-fluorine substituted-apatite. In addition to that, it is possible to obtain the metal-element M, elemental-fluorine substituted-apatite of which aggregates of the primary particles are uniformly dispersed in such a calcium hydroxide suspension (slurry).

An amount of the calcium-based compound as the calcium source contained in the first liquid is preferably in a range of about 0.1 to 3.0 mol/L, and more preferably in a range of about 0.2 to 1.5 mol/L. This makes it possible to more efficiently synthesize the metal-element M, elemental-fluorine substituted-apatite in the next step [S2]. Further, it is also possible to sufficiently stir the first liquid (solution or suspension) at relatively low energy in the next step [S2]. Furthermore, since the first liquid can be stirred sufficiently, it is possible to assist uniformity of a ratio (introduction ratio) of substituting with the divalent metal element M between the primary particles of the metal-element M, elemental-fluorine substituted-apatite to be formed.

[S1-2] Second Liquid (Solution Containing Ion of Divalent Metal Element M) Preparation Step

Next, a second liquid containing an ion of the divalent metal element M (solution containing the ion of the divalent metal element M) is prepared.

Such a second liquid can be obtained by dissolving a compound of the divalent metal element M as an ion source in a solvent.

Examples of the compound of the divalent metal element M as the ion source include, but not limited thereto, an oxide, a nitric compound, a phosphorylated compound, a sulfide, a chloride, a carbonate and the like of the divalent metal element M. These compounds may be used singly or in combination of two or more of them. Among them, in the case where zinc is selected as the divalent metal element M, at least one of zinc oxide and zinc nitrate is preferable as the compound of the divalent metal-element M as the ion source.

When the primary particles of hydroxyapatite are synthesized in the next step [S2], Ca of the hydroxyapatite is efficiently substituted with Zn of the divalent metal element M. Consequently, Zn is reliably introduced into the crystal lattice of apatite. In particular, even if zinc oxide and/or zinc nitrate having a high concentration are used, it is possible to reliably to suppress or prevent tricalcium phosphate (TCP) and calcium fluoride of secondary reaction products from being mixed as a impurity into the synthesized metal-element M, elemental-fluorine substituted-apatite.

A solvent to dissolve the compound of the divalent metal element M as the ion source is not particularly limited, and any solvent can be used as long as any reactions in the next step [S2] are not inhibited.

Examples of such a solvent include water, an alcohol such as methanol and ethanol, a phosphoric acid aqueous solution and the like. These solvents may be used by mixing them. Among them, water is particularly preferred. By using water as a solvent, it is possible to more reliably prevent the inhibition of the reaction to be carried out in the next step [S2]. Further, in the case where zinc oxide is selected as the ion source, the solvent is preferably phosphoric acid aqueous solution from the point of view of solubility.

[S1-3] Third Liquid (Phosphoric Acid-Containing Solution) Preparation Step

Next, a third liquid containing phosphoric acid (phosphoric acid-containing solution) is prepared.

A solvent for dissolving phosphoric acid is not particularly limited, and any solvent can be used as long as it does not inhibit any reactions to be carried out in the next step [S2]. The same solvent as the solvent for dissolving the compound of the divalent metal element described in the above step [S1-2] can be used.

It is preferred that the solvent for dissolving the compound of the divalent metal element M and the solvent for dissolving the phosphoric acid are preferably the same kind of solvent or the same solvent. This makes it possible to uniformly mix the second liquid and the third liquid to the first liquid in a first mixture obtained in the next step [S2]. As a result, it is possible to obtain an uniform introduction ratio of the divalent metal element M in the synthesized metal-element M, elemental-fluorine substituted-apatite.

[S1-4] Fourth Liquid (Hydrogen Fluoride-Containing Solution) Preparation Step

Next, a fourth liquid containing hydrogen fluoride (hydrogen fluoride-containing solution) is prepared.

A solvent for dissolving the hydrogen fluoride is not particularly limited, and any solvent can be used as long as it does not inhibit any reactions to be carried out in the step [S2] which will be described. The same solvent as the solvent for dissolving the compound of the divalent metal element described in the step [S1-2] can be used.

It is preferred that the solvent for dissolving the compound of the divalent metal element M as the ion source and the solvent for dissolving the hydrogen fluoride are preferably the same kind of solvent or the same solvent. This makes it possible to uniformly mix the second liquid and the fourth liquid to the first liquid in the first mixture obtained in the next step [S2]. As a result, it is possible to obtain an uniform ratio (introduction ratio) of substituting with the elemental fluorine in the synthesized metal-element M, elemental-fluorine substituted-apatite.

A first mixture is obtained by mixing the first, second, third and fourth liquids prepared as described above, but the mixing order thereof is not limited as long as the calcium-based compound, the ion of the divalent metal element M, phosphoric acid and hydrogen fluoride can simultaneously exist in the first mixture in which the first, second, third and fourth liquids are mixed in the next step [S2]. However, it is preferred that the second liquid (solution containing the ion of the divalent metal element M) is mixed with the first liquid (solution containing calcium-based compound) to obtain a second mixture, then the third liquid (phosphoric acid-containing solution) is mixed with the second mixture, and thereafter the fourth liquid is further mixed (added) to obtain the first mixture.

By such a mixing order, first, the calcium-based compound, the ion of the divalent metal element M and phosphoric acid are reacted with each other to form metal-element M substituted-apatite having a hydrorxyapatite structure. Thereafter, the hydroxyl groups of the metal-element M substituted-apatite are substituted with the elemental fluorines by making hydrogen fluoride contact with the metal-element M substituted-apatite. Therefore, it is possible to reliably synthesize metal-element M, elemental-fluorine substituted-apatite having the hydroxyapatite structure. As a result, the substantial whole of the particles of the powder obtained in the later step [S3] is constituted from the metal-element M, elemental-fluorine substituted-apatite. Further, it becomes possible to adjust an amount of adding the third liquid with accelerating the substitution between calcium and the divalent metal element M. Thus, the metal-element M, elemental-fluorine substituted-apatite having the apatite structure is obtained with ease by adjusting the adding amount.

In this regard, it is to be noted that examples of a method of obtaining the first mixture in addition to the above method include: a method of substantially simultaneously adding the second liquid, the third liquid and the fourth liquid to the first liquid; a method of substantially simultaneously adding the first liquid and the third liquid to a mixture of the second liquid and the fourth liquid; and a method of substantially simultaneously adding the first liquid, the second liquid and the third liquid to the fourth liquid.

Hereinafter, a description will be made, as a representative, with respect to the case where after the second mixture is prepared, the third liquid is mixed with the second mixture and then the fourth liquid is further mixed to obtain the first mixture, thereby synthesizing the metal-element M, elemental-fluorine substituted-apatite.

[S2] Metal-Element M, Elemental-Fluorine Substituted-Apatite Synthesis Step (Second Step)

[S2-1] Second Mixture Preparation Step

First, the first liquid and the second liquid, which are prepared in the above steps [S1-1] and [S1-2], are mixed to each other to obtain the second mixture.

An amount of the compound of the divalent metal element M as the ion source contained in the second mixture is preferably in a range of about 0.01 to 1.0 mol/L, and more preferably in a range of about 0.05 to 0.5 mol/L. This makes it possible to efficiently substitute Ca of the primary particles of hydroxyapatite with the divalent metal element M in the step [S2].

An amount of the calcium-based compound contained in the second mixture is preferably in a range of about 1.0 to 20.0 mol/L, and more preferably in a range of about 1.5 to 10.0 mol/L. By setting the amount of the calcium-based compound to a value within the above range, the metal-element M, elemental-fluorine substituted-apatite can be synthesized in the present step [S2] efficiently.

The amount of the compound of the divalent metal element M as the ion source contained in the second mixture is preferably in a range of about 20 to 100 times in a mol amount, and more preferably in a range of about 40 to 70 times in a mol amount with respect to the amount of the calcium-based compound contained in the second mixture. This makes it possible to efficiently synthesize the metal-element M, elemental-fluorine substituted-apatite having a high introduction ratio of the divalent metal element M.

[S2-2] Mixing Step of Third Liquid and Fourth Liquid to Second Mixture

Next, the third liquid (phosphoric acid-containing solution) prepared in the above step [S1-3] is mixed with the second mixture obtained in the above step [S2-1] and then the fourth liquid prepared in the above step [S1-4] is further mixed to obtain the first mixture. Then, the calcium-based compound as a calcium source, the ion of the divalent metal element M, phosphoric acid and hydrogen fluoride are reacted with each other in the first mixture to thereby obtain primary particles of the metal-element M, elemental-fluorine substituted-apatite.

As described above, the metal-element M, elemental-fluorine substituted-apatite, in which Cas of hydroxyapatite are substituted with the divalent metal element M and the hydroxyl groups are substituted with the elemental fluorines, can be synthesized because the compound of the divalent metal element M, phosphoric acid and hydrogen fluoride can be in contact with the calcium-based compound (e.g. calcium hydroxide) with a simple handling that the third liquid and the fourth liquid are mixed with the second mixture in this order.

In this embodiment, the third liquid is mixed with the second mixture, and then the fourth liquid is further mixed with them. Therefore, it is considered that the hydroxyl groups of the metal-element M substituted-apatite are substituted with the elemental fluorines by making the hydrogen fluoride contact with the metal-element M substituted-apatite after the metal-element substituted-apatite having the hydroxyapatite structure is formed by reacting the calcium-based compound, the ion of the divalent metal element M and phosphoric acid with each other. As a result, it becomes possible to reliably synthesize the metal-element M, elemental-fluorine substituted-apatite having the hydroxyapatite structure.

Therefore, the primary particles of the synthesized metal-element M, elemental-fluorine substituted-apatite are constituted from the compound represented by the above general formula (1) over the whole thereof. Further, the obtained primary particles of the metal-element M, elemental-fluorine substituted-apatite have high introduction ratios (substitution ratios) of the divalent metal element M and the elemental fluorine.

If a state of mixing the third liquid and the second mixture is maintained without adding hydrogen fluoride (forth liquid), the metal-element M, substituted-apatite, in which Cas of hydroxyapatite are substituted with the metal elements M, is synthesized, which will be described later. In the present invention, when Cas of hydroxyapatite are substituted with the metal elements M, the hydroxyl groups are substituted with elemental fluorines. By doing so, even if the substitution ratio of the metal element M in apatite increases, the metal-element M, elemental-fluorine substituted-apatite to be synthesized maintains the clear apatite structure. It is considered that the results are caused by improving the stability of the metal-element M, elemental-fluorine substituted-apatite by substituting the hydroxyl groups included in the hydroxyapatite structure with the elemental fluorines.

A size of the primary particles of the metal-element M, elemental-fluorine substituted-apatite synthesized as described above is finer than that of the primary particles of the hydroxyapatite in which Ca and the hydroxyl group are not substituted with the divalent metal element M and the elemental fluorine, respectively. Therefore, a specific surface area of dried particles (powder) which is obtained in the next step [S3] and by granulating the primary particles and aggregates thereof is improved. As a result, the adsorption apparatus 1 provided with the dried powder or sintered powder thereof as the adsorbent 3 is capable of separating a large number of isolation materials such as the protein. In this regard, it is to be noted that a concrete specific surface area of the particles of the dried powder will be described in the next step [S3] in detail.

An amount of hydrogen fluoride is not particularly limited, but preferably in a range of about 7.0 to 35.0 mol %, and more preferably in a range of about 10.0 to 25.0 mol % with respect to the calcium-based compound as the calcium source contained in the first mixture. This makes it possible to more efficiently synthesize the metal-element M, elemental-fluorine substituted-apatite having the high substitution ratio of the elemental fluorine.

The third liquid and the second mixture may be mixed together at one time and then mixed with fourth liquid at further one time to obtain the first mixture, but they are preferably mixed by adding the third liquid into the second mixture drop by drop and then further adding the fourth liquid to obtain the first mixture. By dropping the third liquid and the fourth liquid into the second mixture drop by drop in this order, it is possible to form the hydroxyapatite structure in which Cas are substituted with the metal elements M with relatively ease, and thereafter substitute the hydroxyl groups with the elemental fluorines.

Further, it is possible to reliably adjust a pH of the first mixture to an appropriate range with ease. Therefore, it is possible to prevent the synthesized metal-element M, elemental-fluorine substituted-apatite from being decomposed and resolved. Consequently, it is possible to obtain the primary particles of the metal-element M, elemental-fluorine substituted-apatite having a large specific surface area with a high yield and a high purity.

A rate of dropping the third liquid and the fourth liquid into the second mixture is preferably in a range of about 1 to 100 L/hr, and more preferably in a range of about 10 to 100 L/hr. By mixing (adding) the third liquid and the fourth liquid into the second mixture at such a dropping rate, it is possible to react the ion of the divalent metal element M, phosphoric acid and hydrogen fluoride to the calcium-based compound under milder conditions.

Further, when the calcium-based compound, the ion of the divalent metal element M, the phosphoric acid and the hydrogen fluoride are react with each other, namely the metal-element M, elemental-fluorine substituted-apatite is synthesized, the first mixture is preferably stirred. By stirring the first mixture, it is possible to make uniformly contact with each constituent material to allow the reaction to efficiently proceed. In addition, it is possible to obtain the uniform substitution ratios of the divalent metal element M and the elemental fluorine between the primary particles of the obtained metal-element M, elemental-fluorine substituted-apatite. When the adsorbent (dried powder or sintered powder) is produced by using the primary particles of the metal-element M, elemental-fluorine substituted-apatite, for example, an adsorbent having less characteristic variations and high reliability is obtained.

In this case, power for stirring (stirring power) the first mixture (slurry) is preferably in a range of about 0.5 to 3 W, and more preferably in a range of about 0.9 to 1.8 W per 1 liter of the slurry. By setting the stirring power to a value within the above range, it is possible to improve the efficiency of the reaction when the metal-element M, elemental-fluorine substituted-apatite is synthesized.

A temperature when the metal-element M, elemental-fluorine substituted-apatite is synthesized is not particularly limited, but is preferably in a range of about 5 to 50° C., and more preferably in a range of about 5 to 30° C. By setting the temperature to a value within the above range, it is possible to prevent decomposition or dissolution of the synthesized metal-element M, elemental-fluorine substituted-apatite even if a pH of the first mixture is adjusted to relatively a low value. Further, it is also possible to improve a reaction ratio among the calcium-based compound, the ion of the divalent metal element M, the phosphoric acid and the hydrogen fluoride.

In such a manner as described above, the ion of the divalent metal element M, the phosphoric acid and the hydrogen fluoride are reacted to the calcium-based compound, so that the primary particles of the metal-element M, elemental-fluorine substituted-apatite is obtained.

Such primary particles of the metal-element M, elemental-fluorine substituted-apatite exist in the first mixture (slurry) by themselves or in a state of forming aggregates in which the primary particles are aggregated to each other.

[S3] Granulation Step (Third Step)

In the third step, the first mixture (slurry) containing the primary particles of the metal-element M, elemental-fluorine substituted-apatite obtained by completing the above step [S2] and the aggregates thereof are dried and then the primary particles and the aggregates are granulated, so that is obtained powder (dried powder) constituted from secondary particles represented by the above general formula (1) in which at least a part of Cas of hydroxyapatite is substituted with the divalent metal element M and at least a part of the hydroxyl groups is substituted with the elemental fluorine.

In the present invention, the primary particles of the metal-element M, elemental-fluorine substituted-apatite are constituted from the compound represented by the above general formula (1) over the whole thereof. Therefore, the second particles obtained by granulating the primary particles are also constituted from the compound represented by the above general formula (1) over the whole thereof, obviously. In addition, the substitution ratio of the divalent metal element M in the primary particles of the metal-element M, elemental-fluorine substituted-apatite is particularly high. Therefore, it is possible to reliably form the particles in which the contents of the divalent metal element M and the elemental fluorine in the area from the part in which the depth of the particle of the powder is 15 nm to the central part are 3.2 wt % or more and in a range of 0.37 to 3.7 wt %, respectively.

In this regard, a method of drying the slurry is not particularly limited to a specific method, but a spray drying method is preferably used. Accordingly to such a method, it is possible to reliably obtain powder having a predetermined particle size for a short period of time by granulating the primary particles and the aggregates.

A drying temperature of the first mixture is preferably in a range of about 75 to 250° C. and more preferably in a range of about 95 to 220° C. By setting the drying temperature to a value within the above range, it is possible to reliably obtain the secondary particles (powder).

The method of producing the powder according to the present embodiment is suitable to produce powder containing particles having an intended particle size in a range of about 0.1 to 150 μm (in particular, in a range of about 1 to 40 μm).

In this regard, it is to be noted that such powder (dried powder) can be sintered to obtain sintered powder. This makes it possible to improve compressive particle strength (breaking strength) of the powder (sintered powder).

In this case, a sintering temperature of the powder is preferably in a range of about 200 to 800° C. and more preferably in a range of about 400 to 700° C.

The powder (dried powder) constituted from the secondary particles of the compound represented by the above general formula (1) is obtained by completing the steps as described above.

The secondary particles of the dried powder constituted from such secondary particles has a large specific surface area by using the method of producing the powder according to the present invention as described in the above step [S2].

Concretely, a specific surface area of the secondary particles of the dried powder is preferably 70 m²/g or larger, and more preferably in a range of 75 to 200 m²/g or larger. The secondary particles having such a specific surface area can separate a large amount of isolation materials due to a large specific surface area thereof.

The specific surface area of the particles of the sintered powder usually tends to become small by setting a high sintering temperature and a long sintering time in obtaining the sintered particles. However, since the specific surface area of the secondary particles of the dried particles is large as described above, the present invention has an advantage in that sintered powder constituted from particles having a predetermined specific surface area can be obtained by setting sintering conditions such as a sintering temperature and a sintering time in obtaining the sintered particles from the dried particles, or subjecting to a treatment such as a process of further sintering the sintered particles.

<Metal-Element M, Substituted-Apatite>

Next, a description will be made on a case that the compound represented by the above general formula (1) constituting the particles of the powder of the present invention do not include any elemental elements (a case of b=0), namely metal-element M, substituted-apatite and focused on the points differing from the metal-element M, elemental-fluorine substituted-apatite, and an explanation on the common points is omitted.

First, a description will be made on the powder according to the present invention.

The powder according to the present invention is constituted from particles of a compound in which at least a part of Cas of hydroxyapatite is substituted with divalent metal element M, and which are represented by the following general formula (2).

(Ca₁₋ₐMₐ)₁₀(PO₄)₆(OH)₂ (2)

where in the general formula (2) 0<a≦1.

The compound is apatite in which at least a part of Cas of hydroxyapatite is substituted with the divalent metal element M (hereinafter, referred to as “metal-element M, substituted-apatite”). In other words, the compound is a compound which does not include the elemental fluorine of the metal-element M, elemental-fluorine, substituted-apatite. Therefore, the powder constituted from the particles of the metal-element M, substituted-apatite can naturally exhibit the same effects as those of the powder constituted from the particles of the metal-element M, elemental-fluorine, substituted-apatite in which at least a part of Cas of hydroxyapatite is substituted with the divalent metal element M as the description of the metal-element M, elemental-fluorine, substituted-apatite.

It is preferred that the divalent metal element M is uniformly distributed in the insides of the particles of the powder according to the present invention.

Concretely, it is preferred that an amount of the divalent metal element M is 5.0 wt % or more in the inside of each of the particles, namely in an area from a surface of the particle to a central part of the particle. In particular, it is preferred that the amount of the divalent metal element M is 5.0 wt % or more in an area from a part, in which the depth of the particle of the powder is 15 nm, to the central part of the particle. Furthermore, it is preferred that the amount of the divalent metal element M is 5.0 wt % or more in an area from a part, in which the depth of the particle of the powder is 30 nm, to the central part of the particle. By setting the amount of the divalent metal element M in the area from the part of the depth of the particle of the powder to the central part to 5.0 wt % or more, even if the inside of the particle is exposed, it is possible for the powder to reliably exhibit functions as the adsorbent 3.

Further, it is preferred that a content of the divalent metal element M is 5.0 wt % or more in the area from the surface to the central portion of the particle of the powder according to the present invention. In particular, the amount of the divalent metal element M is preferably 5.0 wt % or more in the area from the part, in which the depth of the particle of the powder is 15 nm, to the central part, more preferably in a range of about 5.0 to 10.0 wt %, and even more preferably in a range of about 5.0 to 7.0 wt %. By falling the content of the divalent metal element M in the area from the part in which the depth of the particle of the powder is 15 nm to the central portion within such a range, when the inside of the particle of the powder is exposed, it is possible to reliably exhibit the functions as the adsorbent 3 to the exposed part (inside).

Further, the content of the divalent metal element M is preferably 5.0 wt % or more in the whole of the powder, more preferably in a range of about 5.0 to 10.0 wt %, and even more preferably in a range of about 5.0 to 7.0 wt %. The powder in which the content of the divalent metal element M falls within such a range means powder in which the divalent metal element M are included substantially uniformly in the inside of the particle. Therefore, even if any parts of the particles of the powder are exposed, it is possible for the powder to reliably exhibit the functions as the adsorbent 3.

In addition, a specific surface area of the particles of the powder is preferably in a range of about 20 to 100 m²/g, and more preferably in a range of about 25 to 50 m²/g.

The powder of the present invention as described above can be produced by the method of producing the powder of present invention as follows. The method of producing the powder of present invention is the same as the method of producing the powder of the metal-element M, elemental-fluorine, substituted-apatite, except that the fourth liquid is not used in method of producing the powder of the metal-element M, elemental-fluorine, substituted-apatite.

The method of producing the powder of present invention includes a liquid preparation step S1, a metal-element M, substituted-apatite synthesis step S2 and a granulation step S3. The liquid preparation step S1 is a step of preparing each of liquids to be used in the present invention. The metal-element M, substituted-apatite synthesis step S2 is a step of mixing the prepared liquids with each other to obtain a slurry containing primary particles of the metal-element M, substituted-apatite and aggregates thereof. The granulating step S3 is a step of granulating the primary particles and the aggregates to obtain the powder which is constituted from secondary particles of the compound represented by the above general formula (2). Hereinafter, a description will be made on these steps, and focused on the points differing from the method of producing the powder of the metal-element M, elemental-fluorine substituted-apatite. An explanation on the common points is omitted.

In the case where zinc is selected as the divalent metal element M in the above step [S1-2] “Second Liquid Preparation Step”, zinc oxide or zinc nitrate is preferable as the divalent metal-element M as the ion source. Among them, zinc oxide is more preferable.

In the above step [S2] “Metal-Element M, Elemental-Fluorine Substituted-Apatite Synthesis Step”, a volume ratio A/B of a mixing amount (B [L]) of the second mixture with respect to a mixing amount (A [L]) of the third liquid is in a range of about 1 to 20, and more preferably in a range of about 2 to 8. This makes it possible to obtain the primary particles of the metal-element M, substituted-apatite which are constituted from the compound represented by the above general formula (2) over the whole thereof.

Although the powder, the method of producing the powder, and the adsorption apparatus according to the present invention have been described above with reference to their preferred embodiments, the present invention is not limited to these embodiments.

For example, the method of producing the powder according to the present invention may further include a pre-step before the step [S1], an intermediate step between the step [S1] and the step [S2] or between the step [S2] and the step [S3], and a post-step after the step [S3] for any purpose.

The applications of the metal-element M, elemental fluorine substituted-apatite and the metal-element M, substituted-apatite are not limited to such an adsorbent. For example, the dried powder may be molded and then sintered to obtain a sintered powder. The thus obtained sintered powder can be used as artificial bone or dental root.

### EXAMPLES

Next, a description will be made on concrete Examples of the present invention.

1. Production of Apatite Powder Having Particle Size of 40 μm

### Example 1

—-1A— First, 6.0 L of a calcium hydroxide suspension liquid containing calcium hydroxide of 0.5 mol/L as a calcium source was prepared as a first liquid. Next, 3.0 L of a mixture containing zinc nitrate of 0.1 mol/L as an ion source (second liquid) and phosphoric acid of 0.6 mol/L (third liquid) was prepared. Next, 286 mL of hydrofluoric acid containing hydrogen fluoride of 0.84 mol/L was prepared as a fourth liquid.

In other words, in the Example 1, the first liquid and the forth liquid were prepared so that hydrogen fluoride had a concentration of 8.01 mol % with respect to calcium hydroxide.

—2A— Next, the mixture was dropped into the first liquid at a rate of 20 mL/min in a state that the first liquid was stirred at a rotation speed of 200 rpm to obtain a reaction liquid A (first mixture).

It is to be noted that a pH controller is set to stop at a pH of 8.45 or less of the reaction liquid A at the time of completion of the dropping of the mixture.

After the mixture was dropped, the reaction liquid A containing the first liquid and the mixture was stirred under the conditions of a temperature of 25° C. and a rotation speed of 200 rpm for 2 hours. Thereafter, the fourth liquid was added into the reaction liquid A drop by drop at a rate of 20 mL/min. Thus, calcium hydroxide as the calcium source, zinc nitrate as the ion source, phosphoric acid and hydrogen fluoride were reacted with each other to obtain a slurry containing primary particles of compound represented by the above general formula (1).

In this regard, a content of zinc included in the primary particles was 6.0 wt % and a content of elemental fluorine included in the primary particles was 0.37 wt %.

—3A— Next, the slurry containing the primary particles of the compound represented by the above general formula (1) was spray-dried at 120° C. by using a spray drier (manufactured by OHKAWARA KAKOHKI Co., Ltd. under the trade name of “OC-20”) to obtain dried powder constituted from particulate particles.

—4A— Next, a part of the particles of the dried powder was classified to obtain particles having a median particle size of about 40 μm, and then the particles were sintered in an electric furnace under the conditions of 400° C. for 4 hours to obtain sintered powder constituted from the particles of the compound represented by the above general formula (1). In this regard, it is to be noted that the particles of thus obtained sintered powder had an average particle size of about 40 μm.

### Example 2

Sintered powder constituted from the particles of the compound represented by the above general formula (1) was obtained in the same manner as in the Example 1, except that the fourth liquid was prepared so that hydrogen fluoride had a concentration of 30.60 mol % with respect to calcium hydroxide in the above step —1A— of the Example 1.

In this regard, a content of zinc included in the primary particles was 6.0 wt % and a content of elemental fluorine included in the primary particles was 1.4 wt %.

### Example 3

Sintered powder constituted from particles of the compound represented by the following general formula (2) was obtained in the same manner as in the Example 1, except that a step of preparing the fourth liquid containing hydrogen fluoride and a step of dropping the fourth liquid into the reaction liquid A were omitted. In this regard, a content of zinc included in the primary particles was 6.0 wt %.

(Ca₁₋ₐMₐ)₁₀(PO₄)₆(OH)₂ (2)

where in the formula 0<a≦1.

### Example 4

—1A— First, 6.0 L of a 10% (w/w %, 1.35 M) calcium hydroxide aqueous solution as a calcium source was prepared as a first liquid. Next, ZnO.H₂O of 0.9 mol was added into 10% (1.7 M) phosphoric acid of about 3200 mL and then it was stirred for 3 hours and a half with a magnetic stirrer to prepare a second liquid. Thereafter, a 10% (1.7 M) phosphoric acid aqueous solution was prepared as a third liquid.

—2A— Next, a temperature of the first liquid was maintained 10° C. or less with stirring the first liquid (rotation speed 8000 rpm), and then the first liquid was added into the second liquid drop by drop to obtain a second mixture.

Next, the third liquid was added into the second mixture drop by drop with stirring (rotation speed 8000 rpm) the second mixture which was maintained at 10° C. or less. Thus, a slurry containing primary particles of the compound (b=0) represented by the above general formula (1) was obtained. In this regard, it is to be noted that the third liquid was added into the second mixture drop by drop until the slurry was sintered at 1200° C., appropriately, the obtained sintered powder was analyzed by the XRD using an X-ray diffractometer, and the Ca peak derived from CaO in a spectrum was not observed.

In this regard, a content of zinc (divalent metal element M) included in the primary particles contained in the slurry was 6.4 wt %.

—3A— Next, the slurry containing the primary particles of the compound represented by the above general formula (1) was spray-dried at 220° C. by using a spray drier (manufactured by OHKAWARA KAKOHKI Co., Ltd. under the trade name of “OC-20”) to obtain dried powder constituted from particulate particles.

—4A— Next, a part of the particles of the dried powder was classified to obtain particles having a median particle size of about 40 μm.

### Example 5

Sintered powder constituted from the particles of the compound represented by the above general formula (1) was obtained in the same manner as in the Example 1, except that a mixture was prepared so that zinc nitrate having a concentration of 0.1 mol/L was contained as an ion source in the above step —1A— of the Example 1.

In this regard, a content of zinc (divalent metal element M) included in the primary particles contained in the slurry which was used to obtain the sintered powder was 6.4 wt %.

### Example 6

Sintered powder constituted from the particles of the compound represented by the above general formula (1) was obtained in the same manner as in the Example 1, except that a mixture was prepared so that zinc nitrate having a concentration of 0.15 mol/L was contained as an ion source in the above step —1A— of the Example 1.

In this regard, a content of zinc (divalent metal element M) included in the primary particles contained in the slurry which was used to obtain the sintered powder was 9.6 wt %.

### Example 7

Sintered powder constituted from the particles of the compound represented by the above general formula (1) was obtained in the same manner as in the Example 1, except that a mixture was prepared so that zinc nitrate having a concentration of 0.2 mol/L was contained as an ion source in the above step —1A— of the Example 1.

In this regard, a content of zinc (divalent metal element M) included in the primary particles contained in the slurry which was used to obtain the sintered powder was 12.8 wt %.

### Example 8

Sintered powder constituted from the particles of the compound represented by the above general formula (1) was obtained in the same manner as in the Example 1, except that a mixture was prepared so that zinc nitrate having a concentration of 0.25 mol/L was contained as an ion source in the above step —1A— of the Example 1.

In this regard, a content of zinc (divalent metal element M) included in the primary particles contained in the slurry which was used to obtain the sintered powder was 16.0 wt %.

### Example 9

Sintered powder constituted from the particles of the compound represented by the above general formula (1) was obtained in the same manner as in the Example 1, except that a mixture was prepared so that zinc nitrate having a concentration of 0.3 mol/L was contained as an ion source in the above step —1A— of the Example 1.

In this regard, a content of zinc (divalent metal element M) included in the primary particles contained in the slurry which was used to obtain the sintered powder was 19.2 wt %.

### Comparative Example 1

Hydroxyapatite beads (CHT Typell, average particle size of 40 μm, produced by HOYA CORPORATION) were prepared as powder constituted from particles of hydroxypatite.

### Comparative Example 2

—1B— First, hydroxyapatite beads (CHT Typell, average particle size of 40 μm, produced by HOYA CORPORATION) were prepared as powder constituted from particles of hydroxypatite. Next, the hydroxyapatite beads were suspended in a phosphate buffer of 0.1 mol/L, and then were filled into an adsorbent filling space of a column (inside diameter 4 mm×length 100 mm).

—2B— Next, a reaction liquid B containing zinc nitrate of 0.1 mol/L as an ion source and hydrogen fluoride of 0.84 mol/L was supplied into a column through an inlet pipe for 10 minutes at a flow rate of 1 mL/min, so that Ca and a hydroxyl group existing on a surface of each of the hydroxyapatite beads were substituted with Zn and F, respectively. Thus, sintered powder constituted from the particles of which surfaces were constituted from the compound represented by the above general formula (1) was obtained.

### Comparative Example 3

—1B— First, hydroxyapatite beads (CHT Typell, average particle size of 40 μm, produced by HOYA CORPORATION) were prepared as sintered powder constituted from particles of hydroxypatite. Next, the hydroxyapatite beads were suspended in a phosphate buffer of 0.1 mol/L, and then were filled into an adsorbent filling space of a column (inside diameter 4 mm×length 100 mm). In this regard, it is to be noted that an amount of the sintered powder filled into the adsorbent filling space was 1 g (about 1 mmol).

—2B— Next, a second liquid B containing zinc nitrate of 0.1 mol/L as an ion source was supplied into the column through an inlet pipe for 10 minutes at a flow rate of 1 mL/min, so that Ca existing on a surface of each of the hydroxyapatite beads was substituted with Zn. Thus, sintered powder constituted from the particles of the compound represented by the above general formula (2) was obtained.

### Reference Example 1

Was prepared sintered powder which was constituted from particles of tricalcium phosphate produced by using a well-known method.

2. Evaluation

2-1. Evaluation of Apatite Component in Slurry

First, was sampled 10 mL of a slurry containing the primary particles of each of the compounds represented by the above general formulae (1) and (2) which were obtained in the step 1A in each of the Examples 1 to 9. Then, the slurry was dried at a temperature of 100° C. for 1 hour in a drying machine. Thereafter, thus obtained dry matter was crushed with an agate mortar and then the crushed dry matter was added into a crucible made from aluminum. The crucible was sintered at a temperature 1200° C. for 15 hours after rising by a temperature of 1200° C. for 40 minutes in an electric furnace. Thus, the crushed dry matter was sintered by natural cooling.

The sintered powder obtained in each of the Examples 1 to 9, the Comparative Example 1 and the Reference Example 1 was analyzed by the XRD using an X-ray diffractometer (“RINT” produced by Rigaku Corporation).

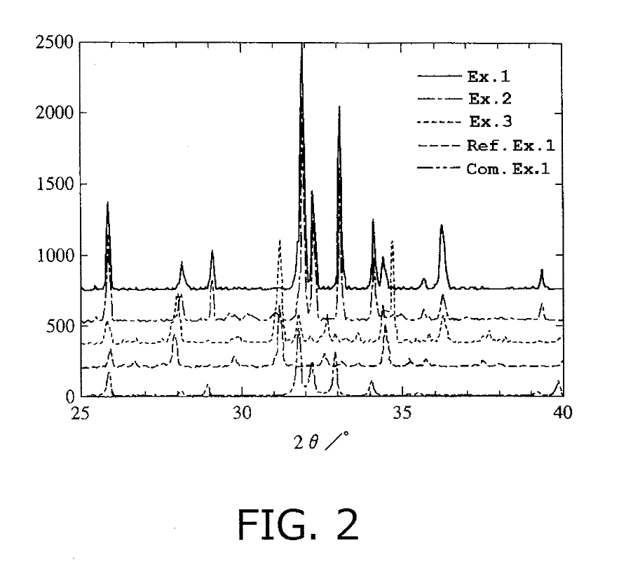

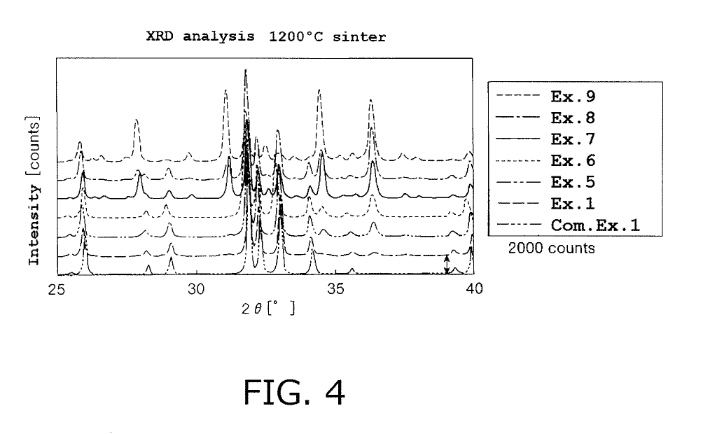

The results obtained by analyzing with the XRD the sintered powder which was obtained in each of the Examples 1 to 3, the Comparative Example 1 and the Reference Example 1 are shown in FIG. 2. The results obtained by analyzing with the XRD the sintered powder which was obtained in each of the Examples 1 and 5 to 9 and the Comparative Example 1 are also shown in FIG. 4. In this regard, it is to be noted that the XRD was performed under the conditions as shown in the following Table 1.

TABLE 1
Measurement conditions

| X-ray | Cu K-ALPHA 1/40 kV/50 mA |
|---|---|
| Goniometer | RINT2000 Vertical type goniometer |
| Sampling time | 3.00 second |
| Step angle | 0.02° |
| Scan axis | 2θ/θ |
| Scan range | 25~40°, 10~60° |

As shown in FIG. 2, in the Examples 1 and 2 in which hydrogen fluoride having a concentration in a range of about 8 to 30 mol % to calcium hydroxide was used, it is confirmed that an structure of the metal-element M, elemental-fluorine, substituted-apatite constituting the particles of the sintered powder was the same hydroxyapatite structure as that of the hydroxyapatite beads of the Comparative Example 1.

From this result, it is found that the Ca and the hydroxyl group in the apatite were reliably substituted with Zn and F, respectively, while the hydroxyapatite structure was maintained in the Examples 1 and 2.

In contrast, in the Example 3 in which the addition of hydrogen fluoride was omitted, peaks derived from tricalcium phosphate were observed in 2θ=34.4° due to the inclusion of a large amount of zinc nitrate, which was the same results as those of the Reference Example 1. Further, peaks derived from zinc oxide were also observed in 2θ=34.4°. From these results, it was found that impurities were included in the slurry.

In the present invention, when the compound represented by the above general formula (1) was obtained, in the case where hydrogen fluoride was mixed, it was found that the compound represented by the above general formula (1) having the apatite structure was synthesized reliably. Further, it was found that it was possible to reliably suppress or prevent the impurities from being mixed in the slurry containing the compound.

Further, as shown in FIG. 4, in the Examples 1, 5 and 6 in which the amount of zinc nitrate in the mixture was in a range of 0.05 to 0.15 mol/L, namely the content of zinc in the primary particles was in a range of 3.2 to 9.6 wt %, it was confirmed that a structure of the metal-element M, substituted-apatite of the particles constituting the sintered powder was the same hydroxyapatite structure as that of the hydroxyapatite beads of the Comparative Example 1.

From these results, it was found that the Ca in the apatite was reliably substituted with Zn in the Examples 1, 5 and 6.

In contrast, in the Examples 7 to 9 in which the amount of zinc nitrate in the second mixture was in a range of 0.2 to 0.3 mol/L, peaks derived from tricalcium phosphate and zinc oxide were observed in 2θ=31.1° and 2θ=34.4°, respectively. In other words, the structure of the metal-element M, substituted-apatite of the particles constituting the sintered powder had structures derived from tricalcium phosphate and zinc oxide in addition to the same hydroxyapatite structure as that of the hydroxyapatite beads of the Comparative Example 1. From these results, it was found that impurities were included in the slurry in addition to the compound represented by the above general formula (1).

For these results, it was considered that in the sintered powder obtained in each of the Examples 7 to 9, which was obtained by using the slurry containing the primary particles in which the content of zinc was in a range of 3.2 to 19.2 wt % as the Examples 7 to 9, the content of zinc became 3.2 wt % or more over the particles.

Further, the apatite component was evaluated in the same manner as in the Examples 1 to 9, except that zinc oxide was used in place of zinc nitrate contained in the second mixture as the ion source and a phosphoric acid aqueous solution of zinc oxide was used as the second liquid. In this case, in even the case where an amount of zinc oxide in the second mixture was large, peaks derived from tricalcium phosphate and zinc oxide were hardly observed. From this result, it became clear to reliably suppress the impurities from being mixed into the slurry.

2-2. Evaluation of Adsorption Property of Histidine

First, the sintered powder obtained in the each of the Examples 1 and 4 and the Comparative Example 1 was suspended in a phosphate buffer of 0.1 mol/L to obtain a suspension liquid. Thereafter, the suspension liquid was filled into an adsorbent filling space of a column (inside diameter 4 mm×length 100 mm) to obtain an adsorption apparatus.

Next, in the adsorption apparatus using the sintered powder obtained in each of the Example 1 and the Comparative Example 1, adsorption property of dihistidine was examined as follows. Further, in the adsorption apparatus using the sintered powder obtained in each of the Example 4 and the Comparative Example 1, adsorption property of histidine was also examined as follows.

First, the liquid included in the column of the adsorption apparatus was substituted with a phosphate buffer of 10 mM (pH 6.8).

Next, in the adsorption apparatus using the sintered powder obtained in each of the Example 1 and the Comparative Example 1, a sample solution of 50 μL in which a sample was dissolved in the same phosphate buffer as the above was supplied into the column so that a concentration of dihistidine became 1 mg/mL. Then, the sample solution passed through the column.

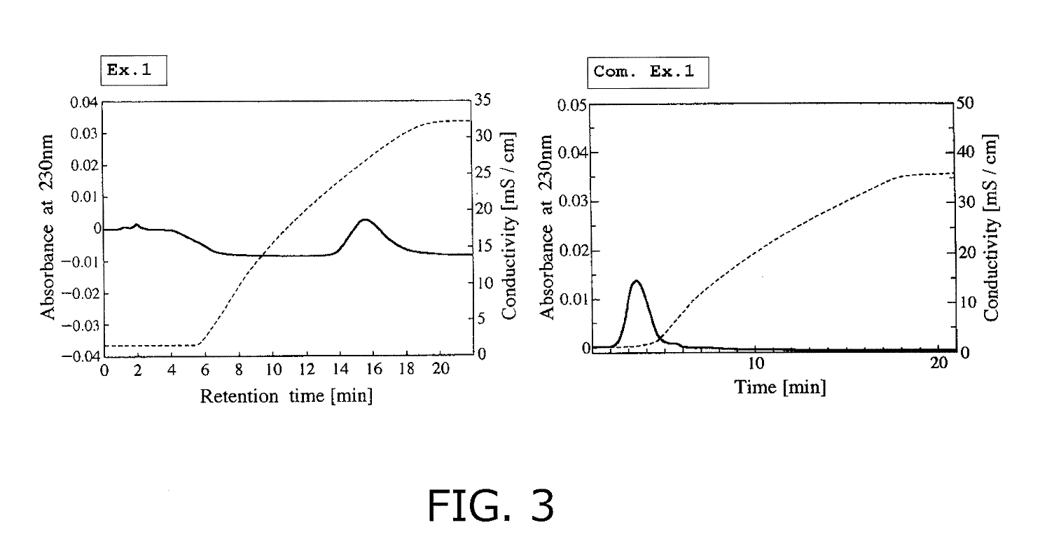

Next, the phosphate buffer of 10 mM (pH 6.8) and a phosphate buffer of 400 mM (pH 6.8) were supplied into the column at a flow rate of 1 mL/min for 15 minutes so that a concentration of the phosphate buffer of 400 mM was continuously changed in a range of 0 to 100%. Then, a liquid discharged from the column was fractionated at every 1 mL. In this regard, dihistidine in the liquid discharged from the column was detected by measuring an absorbance in a wavelength of 230 nm. The results are shown in FIG. 3.

As clearly seen from FIG. 3, the dihistidine contained in the sample solution could not adsorb to the adsorbent of the adsorption apparatus in the Comparative Example 1 for a long period of time. As compared with that, the dihistidine contained in the sample solution could adsorb to the adsorbent of the adsorption apparatus in the Example 1 for about 15 minutes. From the results, it was found that Ca of apatite of the particles of the sintered powder obtained in the Example 1 was reliably substituted with Zn, so that the dihistidine having an excellent chelate forming ability to Zn was capable of adsorbing for a long period of time.

On the other hand, in the adsorption apparatus using the sintered powder obtained in each of the Example 4 and the Comparative Example 1, a sample solution of 50 μL in which a sample was dissolved in the same phosphate buffer as the above was supplied into the column so that a concentration of each of monohistidine, dihistidine, tetrahistidine and hexahistidine became 1 mg/mL. Then, the sample solution passed through the column.

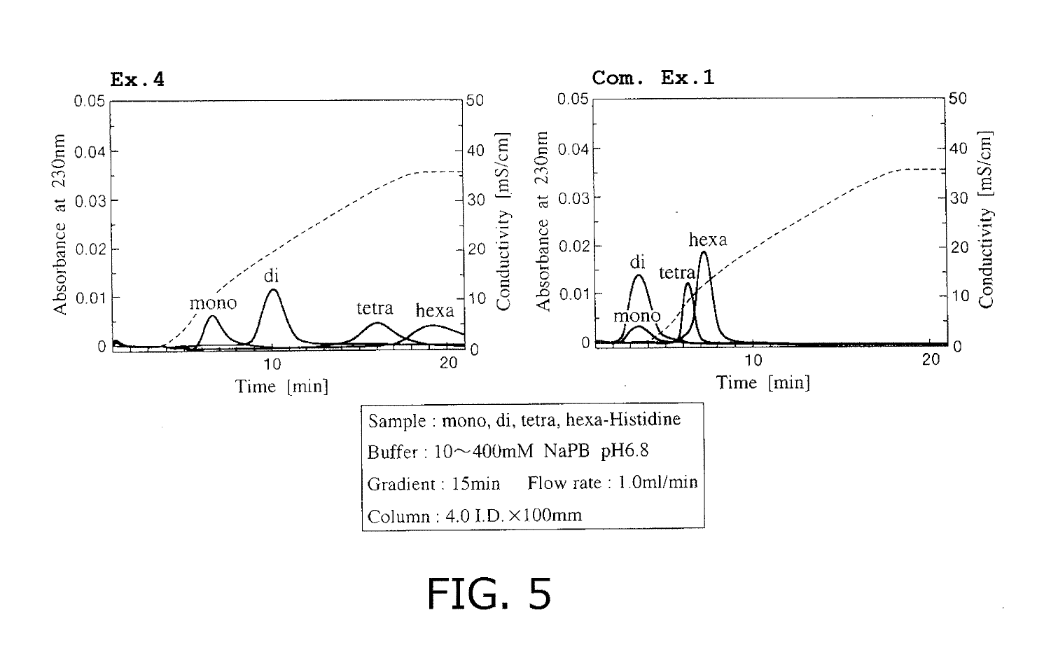

Next, the phosphate buffer of 10 mM (pH 6.8) and the phosphate buffer of 400 mM (pH 6.8) were supplied into the column at the flow rate of 1 mL/min for 15 minutes so that the concentration of the phosphate buffer of 400 mM was continuously changed in a range of 0 to 100%. Then, the liquid discharged from the column was fractionated at every 1 mL. In this regard, each histidine in the liquid discharged from the column was detected by measuring an absorbance in the wavelength of 230 nm. The results are shown in FIG. 5.

As clearly seen from FIG. 5, each histidine (monohistidine, dihistidine, tetrahistidine and hexahistidine) contained in the sample solution could not be separated from each other in the adsorption apparatus of the Comparative Example 1. As compared with that, each histidine contained in the sample solution could be reliably separated from each other in the adsorption apparatus of the Example 4. From the results, it was found that Ca of apatite of the particles of the sintered powder obtained in the Example 4 was reliably substituted with Zn, so that each histidine having an excellent chelate forming ability to Zn was reliably capable of separating from each other.

2-3. Evaluation of Contents of Zn and F in Sintered Powder

The sintered powder obtained in each of the Example 4 and the Comparative Examples 1 and 2 was subjected to a X-ray photoelectron spectrometer (“ESCA-3200” produced by Shimadzu Corporation) to measure a content of Zn in a direction of the depth of the particle of the powder.

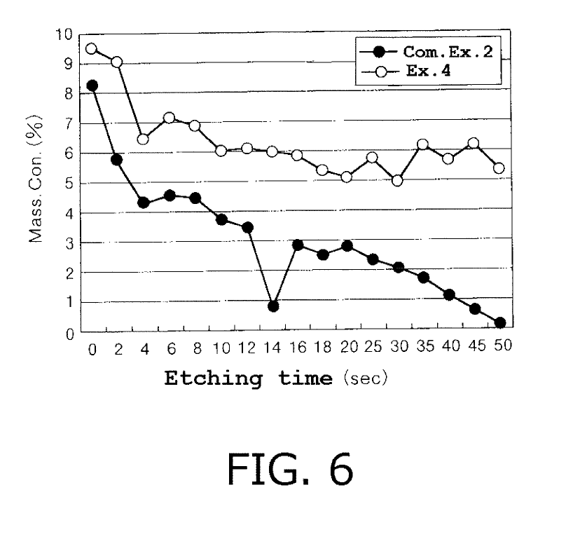

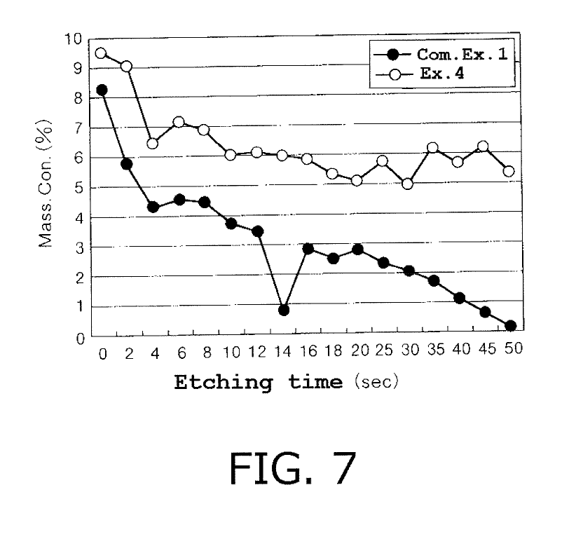

The results obtained by a X-ray photoelectron spectroscopy (XPS method) of the sintered powders obtained in the Example 4 and the Comparative Example 2 are shown in FIG. 6. Further, the results obtained by the X-ray photoelectron spectroscopy (XPS method) of the sintered powders obtained in the Example 4 and the Comparative Example 1 are also shown in FIG. 7. In this regard, the measurement by the X-ray photoelectron spectrometer was performed under the conditions shown in Table 2 below. A relation between an etching time [second] and the depth of the particle of the sintered powder (etching distance) [nm] is shown in Table 3.

TABLE 2
Measurement conditions

| | |
|---|---|
| X-ray | Mg 8 kV/30 mA |
| Etching | Argon ion etching |
| Etching rate | SiO² conversion ≈ 0.52 nm/second |
| Etching conditions | 1 second ethching × 20 times |

TABLE 3
Table 3

| | Etching time [second] | | | | | | | | | | | | | | | | |
|---|---|---|---|---|---|---|---|---|---|---|---|---|---|---|---|---|---|
| | 0 | 2 | 4 | 6 | 8 | 10 | 12 | 14 | 16 | 18 | 20 | 25 | 30 | 35 | 40 | 45 | 50 |
| Etching | 0 | 1.04 | 2.08 | 3.12 | 4.16 | 5.20 | 6.24 | 7.28 | 8.32 | 9.36 | 10.4 | 13.0 | 15.6 | 18.2 | 20.8 | 23.4 | 26.0 |
| distance | | | | | | | | | | | | | | | | | |
| [nm] | | | | | | | | | | | | | | | | | |

As shown in FIGS. 6 and 7, the content of Zn in the particles of the sintered powder obtained in the Example 4 was 5.0 wt % or more in the area from the surface to the central part of the particle, in particular, in even the area from the part, in which the depth of the particle is 15 nm, to the central part. Further, the content of Zn was in a range of 5.0 to 10.0 wt % in even any measured parts in which the depth of the particle was in a range of about 0 to 26 nm.

In such sintered powder obtained in the Example 4, it is considered that Zn having a high concentration is included over the particles. Even if any parts of the particles of the sintered powder are exposed, it is considered that the powder is capable of exhibiting enough functions as the adsorbent.

In contrast, in the sintered powder obtained in each of the Comparative Examples 1 and 2, the content of Zn was 8.0 wt % or more in the vicinities of the particles of the sintered powder. However, the content was gradually lowered depending on the depth of the particle of the powder. Was obtained a result that the content of Zn became 0 wt % in the depth of the particle of 26 nm.

In the case where the vicinities of the surfaces of the particles are exposed, the sintered powders obtained in the Comparative Examples 1 and 2 are capable of exhibiting the functions as the adsorbent. However, if the insides of the particles are exposed (in particular, the area from the part, in which the depth of the particle is 26 nm, to the central part of the particle is exposed), the sintered powders obtained in the Comparative Examples 1 and 2 show the same characteristics as those of the sintered powders of hydroxyapatite (Comparative Examples 1 and 4). As a result, it is considered that it is difficult to reliably separate a compound such as histidine having the excellent chelate forming ability to Zn.

Further, as described above, since Ca is substituted with Zn over the particles of the sintered powder in the Example 4, it is considered when the slurry of the primary particles is obtained, Ca is substituted with Zn. Further, it is also considered that Ca is substituted with Zn and the hydroxyl group is substituted with the elemental fluorine over the particles of the sintered powder which is obtained in each Example and is constituted from the particles of the compound represented by the above general formula (1) in which the hydroxyl group is substituted with the fluorine atom as the Examples 1 and 2.

### INDUSTRIAL APPLICABILITY

The powder according to the present invention has excellent durability and is capable of reliably separating and purifying a target compound with ease when it is used for an adsorbent used in an adsorption apparatus. Therefore, the powder according to the present invention has industrial applicability.

What is claimed is:

1. Powder constituted from particles of a compound represented by the following general formula (1),
(Ca₁₋ₐMₐ)₁₀(PO₄)₆((OH)_{1-b}F_{b})₂ (1)
where in the formula M is a divalent metal element, and the following relations are satisfied: 0<a≦1 and 0≦b≦1,
wherein each of the particles has a surface, a central part, a specific distance part in which a distance from the surface toward the central part is 15 nm, and an area part from the specific distance part to the central part, and
wherein an amount of the divalent metal element is 3.2 wt % or more in the area part.

2. The powder as claimed in claim 1, wherein the “b” in the general formula (1) satisfies a relation of 0<b≦1,
wherein the compound is constituted of hydroxyapatite, at least a part of Cas of the hydroxyapatite is substituted with the divalent metal element M and at least a part of hydroxyl groups is substituted with an elemental fluorine.

3. The powder as claimed in claim 2, wherein an amount of the divalent metal element M is 3.2 wt % or more in the whole of the particles of the powder.

4. The powder as claimed in claim 2, wherein an amount of the elemental fluorine is in a range of 0.37 to 3.7 wt % in the area part of each of the particles.

5. The powder as claimed in claim 2, wherein a content of the elemental fluorine is in a range of 0.37 to 3.7 wt % in the whole of the particles of the powder.

6. The powder as claimed in claim 1, wherein the particles are obtained by drying a slurry containing primary particles of the compound represented by the general formula (1) and aggregates thereof and then granulating the primary particles and the aggregates.

7. The powder as claimed in claim 6, wherein the compound is constituted of hydroxyapatite, the primary particles of the compound represented by the general formula (1) are obtained by substituting the Ca and the hydroxyl group included in the primary particles of the hydroxyapatite with the divalent metal element M and the elemental fluorine, respectively.

8. The powder as claimed in claim 1, wherein the compound represented by the general formula (1) forms an apatite structure.

9. The powder as claimed in claim 1, wherein the “b” in the general formula (1) is 0,
wherein the compound is represented by the following general formula (2) in which at least a part of Cas of the hydroxyapatite is substituted with the divalent metal element M:
(Ca₁₋ₐMₐ)₁₀(PO₄)₆(OH)₂ (2)
where in the formula the following relation is satisfied: 0<a≦1.

10. The powder as claimed in claim 9, wherein an amount of the divalent metal element M is 5.0 wt % or more in the area part of each of the particles.

11. The powder as claimed in claim 9, wherein a content of the divalent metal element M is 5.0 wt % or more in the whole of the particles of the powder.

12. The powder as claimed in claim 9, wherein the particles are obtained by drying a slurry containing primary particles of the compound represented by the general formula (2) and aggregates thereof and then granulating the primary particles and the aggregates.

13. The powder as claimed in claim 12, wherein the compound is constituted of hydroxyapatite, the primary particles of the compound represented by the general formula (2) are obtained by substituting the Ca included in the primary particles of the hydroxyapatite with the divalent metal element M.

14. A method of producing the powder defined in claim 1, the method comprising:
preparing a first liquid containing a calcium-based compound containing the Ca;
preparing a second liquid containing the divalent metal element M to obtain an ion thereof;
preparing a third liquid containing phosphoric acid;
mixing the first liquid, the second liquid and the third liquid to obtain a first mixture;
reacting the calcium-based compound, the ion of the divalent metal element M and the phosphoric acid in the first mixture to obtain a slurry containing primary particles of the compound represented by the general formula (1) and aggregates thereof; and
granulating the primary particles and the aggregates contained in the slurry to thereby obtain the powder constituted from the particles.

15. The method as claimed in claim 14, wherein the mixing the first liquid, the second liquid and the third liquid is performed by mixing the first liquid and the second liquid to obtain a second mixture and then mixing the third liquid with the second mixture.

16. The method as claimed in claim 14, wherein the ion of the divalent metal element M is derived from an oxide of the divalent metal element M as an ion source.

17. The method as claimed in claim 14 further comprising preparing a fourth liquid containing hydrogen fluoride,
wherein the mixing the first liquid, the second liquid and the third liquid is performed by mixing the first liquid, the second liquid, the third liquid and the fourth liquid, and
the reacting the calcium-based compound, the ion of the divalent metal element M and the phosphoric acid is performed by reacting the calcium-based compound, the ion of the divalent metal element M, the phosphoric acid and the hydrogen fluoride in the first mixture.

18. The method as claimed in claim 17, wherein the ion of the divalent metal element M is derived from at least one of an oxide and a nitric compound of the divalent metal element M an ion source.

19. An adsorption apparatus provided with the powder defined in claim 1 or sintered powder obtained by sintering the powder.
